(19) United States
(12) Patent Application Publication
(10) Pub. No.: US 2024/0360286 A1
(43) Pub. Date: Oct. 31, 2024

(54) HIGHLY TRANSMISSIVE PTFE DENSE FILM WITH TUNABLE HAZE AND COLOR

(71) Applicant: W. L. Gore & Associates, Inc., Newark, DE (US)

(72) Inventors: Michael B. Minor, Elkton, MD (US); Michael E. Kennedy, Oxford, PA (US); Shaofeng Ran, Kennett Square, PA (US)

(21) Appl. No.: 18/687,513

(22) PCT Filed: Aug. 30, 2021
(86) PCT No.: PCT/US2021/048147

§ 371 Date: Feb. 28, 2024

(51) Int. Cl. C08J 5/18

(52) U.S. Cl. CPC C08J 5/18; C08J 2327/24

(57) ABSTRACT

Dense polytetrafluoroethylene films as well as methods for preparing the present materials are provided having superior optical properties (highly transmissive, low haze, low yellowness) in combination with desirable mechanical properties (such as flexibility, strength, and durability). The highly transmissive dense films are suitable for use in a variety of optical applications, such as a cover layer for a screen in a portable electronic device.

### CROSS-REFERENCE TO RELATED APPLICATION

This application is a national phase application of PCT Application No. PCT/US2021/048147, internationally filed on Aug. 30, 2021, which is herein incorporated by reference in its entirety for all purposes.

### FIELD

The present disclosure relates generally to a dense polytetrafluoroethylene (PTFE) sheet or film, having superior optical properties (highly transmissive, low haze, low yellowness) in combination with desirable mechanical properties (such as flexibility, strength, and durability), articles including the films, and processes for manufacture of said film which include a combination of thermal treatment and stretching of polytetrafluoroethylene.

### BACKGROUND

Barrier films are used in a wide variety of technologies, including medical and commercial devices. For example, barrier films find use as protective layers in electronic device displays, in short and long term implantable medical devices, seals, gaskets, blood contact surfaces, bags, containers, and fabric liners. In addition to good barrier properties, depending on their use, barrier films should have good mechanical properties, be thermally stable and have excellent optical properties. Monolithic, multi-component, and multilayered barrier films have been constructed as barrier materials, but have not provided a combination of optical properties, strength, and barrier properties.

Polytetrafluoroethylene (PTFE) has been evaluated for use as barrier films. The use of PTFE is advantageous in that it can be used in harsh chemical environments and over a broad range of temperatures. For example, PTFE has exhibited utility as a material for use in harsh chemical environments where other polymers quickly degrade. PTFE also has a useful temperature range from as high as about 260° C. to as low as about −273° C. Historically. PTFE barrier films were characterized by poor mechanical properties such as low tensile strength, poor cold flow resistance or creep resistance, poor cut-through and abrasion resistance, and a general poor mechanical integrity that precludes its consideration in many materials engineering applications.

Low porosity PTFE articles have been made through the use of a skiving process in which solid PTFE films are split or shaved from a thicker preformed article. These PTFE articles are characterized by low strength, poor cold flow resistance, and poor load bearing capabilities in both the length and width directions of the film. Processes such as ram extrusion of PTFE fine powder have also been used to produce low porosity PTFE articles; however, such films also possess relatively poor mechanical characteristics. Attempts have also been made to strengthen the low porosity PTFE films by stretching in the length dimension. However, strength gains are minimal and, by the nature of the process, are achieved in only a single dimension, thus greatly minimizing the utility of the film.

An expanded polytetrafluoroethylene (ePTFE) film may be produced by a process taught in U.S. Pat. No. 3,953,566, to Gore The porous ePTFE formed by the process has a microstructure of nodes interconnected by fibrils, demonstrates higher strength than unexpanded PTFE, and retains the chemical inertness and wide useful temperature range of unexpanded PTFE. However, such an expanded PTFE film is porous and therefore cannot be used as a barrier layer to low surface tension fluids since such fluids with surface tensions less than 50 dyne-cm pass through the pores of the membrane.

Compressed ePTFE articles in which a platen press was used to densify a thin sheet of ePTFE with and without heat are also taught in U.S. Pat. No. 3,953,566 to Gore. However, cold flow occurred in the press, non-uniform parts resulted, and a density of over 2.1 g/cc was not achieved. Accordingly, the utility of the ePTFE sheet as a barrier film was limited.

Thus, there exists a need in the art for a tetrafluoroethylene-based dense films exhibiting superior optical properties including being highly transmissive, and having low haze and low yellowness without compromising existing superior chemical and mechanical properties such as flexibility, strength, and durability.

### SUMMARY

Provided herein are a dense polytetrafluoroethylene (PTFE) film and articles including these films exhibiting superior optical properties (highly transmissive, low haze, low yellowness) in combination with desirable mechanical properties (such as flexibility, strength, and durability), and a process to prepare the films.

This invention provides for a dense PTFE film having excellent optical properties, without compromising existing mechanical, chemical, and thermal characteristics of traditional dense PTFE sheets or films. Sheets and films of the invention can be made in unusually thin form but also be of substantial thickness.

According to a first embodiment (“Embodiment 1”), an article is provided that includes a dense polytetrafluoroethylene (PTFE) film having an average haze coefficient of less than about 6% from 360 nm to 780 nm and/or a reduced scattering coefficient less than or equal to 2.9 mm⁻¹ at 400 nm.

According to a second embodiment further to Embodiment 1 (“Embodiment 2”), the article may have an average total transmittance measured from 360 nm to 780 nm of at least 93%.

According to a third embodiment further to any preceding Embodiment (“Embodiment 3”), the article may have a yellowness index of about 3.0 or less.

According to a fourth embodiment further to any preceding Embodiment (“Embodiment 4”), the dense film may have a thickness from about 0.04 μm to about 1.0 mm.

According to a fifth embodiment further to any preceding Embodiment (“Example 5”), the dense PTFE film may have a matrix tensile strength in a machine direction and a transverse direction of at least 69 MPa.

According to a sixth embodiment further to any preceding Embodiment (“Embodiment 6”), the dense PTFE film may have a thickness normalized methane permeability less than about 20 μg*micron/cm²/min.

According to a seventh embodiment further to any preceding Embodiment (“Embodiment 7”), the dense PTFE film may include from about 0.001 to about 1 wt % of at least one ethylenically unsaturated monomer.

According to an eighth embodiment further to any preceding Embodiment (“Embodiment 8”), the ethylenically unsaturated monomer may be a perfluoroalkylethylene having a formula F(CF₂)ₙCH═CH₂ wherein n is 4, 5, 6, 7, 8, 9 or 10.

According to a nineth embodiment further to preceding Embodiments 7 or 8 (“Embodiment 9”), the ethylenically unsaturated monomer may be perfluorobutyl ethylene or perfluoro-octylethylene.

According to a tenth embodiment further to any preceding Embodiment (“Embodiment 10”), the article may be in the form of a sheet, a tube, or a self-supporting three-dimensional shape.

According to an eleventh embodiment further to any preceding Embodiment (“Embodiment 11”), the article maybe a portable electronic device display, a flexible display, a solar panel, a personal computer, a television, a storage container or a sensor.

According to a twelfth embodiment (“Embodiment 12”), a laminate is provided that includes the article of any preceding embodiment.

According to a thirteenth embodiment (“Embodiment 13”), a process to form a dense polytetrafluoroethylene film is provided, including:
stretching a dried PTFE preform tape comprising modified PTFE resin having a raw dispersion particle size of less than 240 nm, in at least one direction at a temperature at or above PTFE crystalline melting temperature to form a dense polytetrafluoroethylene (PTFE) film having
(a) an average haze coefficient of less than about 6% from 380 nm to 780 nm; and
(b) a reduced scattering coefficient less than or equal to 2.9 mm-1 at@400 nm.

According to a fourteenth embodiment further to Embodiment 13 (“Embodiment 14”), the stretching may occur at a temperature from about 350° C. to about 400° C.

According to a fifteenth embodiment further to any preceding Embodiments 13 to 14 (“Embodiment 15”), the stretching step may use a stretch ratio of 5:1 or less in both the machine direction (MD) and the transverse direction (TD).

According to a sixteenth embodiment further to any preceding Embodiment 13 to 15 (“Embodiment 16”), the dense polytetrafluoroethylene film may have a matrix tensile strength in a machine direction and a transverse direction of at least 69 MPa.

According to a seventeenth embodiment further to any preceding Embodiment 13 to 16 (“Embodiment 17”), the dense polytetrafluoroethylene film may have a void volume less than about 20%.

According to an eighteenth embodiment further to any preceding Embodiment 13 to 17 (“Embodiment 18”), the dense PTFE film has a methane permeability less than about 20 μg*micron/cm²/min.

According to a nineteenth embodiment further to any preceding Embodiment 13 to 18 (“Embodiment 19”), the dried PTFE preform tape may be formed from a PTFE resin comprising from about 0.001 wt % to about 1 wt % of at least one ethylenically unsaturated monomer.

According to a twentieth embodiment further to Embodiment 19 (“Embodiment 20”), the ethylenically unsaturated monomer may be a perfluoroalkylethylene having a formula F(CF₂)ₙCH═CH₂ wherein n is 4, 5, 6, 7, 8, 9 or 10.

According to a twenty-first embodiment further to Embodiment 19 or 20 (“Embodiment 21”), the ethylenically unsaturated monomer may be perfluorobutyl ethylene or perfluoro-octylethylene.

According to a twenty-second embodiment further to Embodiment 13 to 21 (“Embodiment 22”), the dense film has a thickness from about 0.04 μm to about 1.0 mm.

According to a twenty-third embodiment further to Embodiment 13 to 22 (“Embodiment 23”),
the dried PTFE preform tape may be formed by process steps including:
(a) lubricating a population of polytetrafluoroethylene (PTFE) resin particles having a raw dispersion particle size from about 110 nm to about 240 nm to form a blend of lubricated particles;
(b) subjecting the blend of lubricated particles to a temperature below about 350° C. under sufficient pressure to form a lubricated pellet;
(c) extruding the lubricated pellet to form a lubricated polytetrafluoroethylene preform tape; and
(d) heating the lubricated polytetrafluoroethylene preform tape to remove the lubricant to form a dried PTFE preform tape.

According to a twenty-fourth embodiment further to Embodiment 23 (“Embodiment 24”), the population of PTFE resin particles may include from about 0.001 wt % to about 1 wt % of at least one ethylenically unsaturated monomer.

According to a twenty-fifth embodiment further to Embodiment 23 or 24 (“Embodiment 25”), the ethylenically unsaturated monomer may be a perfluoroalkylethylene having a formula F(CF₂)ₙCH═CH₂ wherein n is 4, 5, 6, 7, 8, 9 or 10.

The foregoing Embodiments are just that, and should not be read to limit or otherwise narrow the scope of any of the inventive concepts otherwise provided by the instant disclosure. While multiple embodiments are disclosed, still other embodiments will become apparent to those skilled in the art from the following detailed description, which shows and describes illustrative examples Accordingly, the drawings and detailed description are to be regarded as illustrative in nature rather than restrictive in nature.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. When ranges are listed in the specification and in the claims, it is understood that all the numbers including decimals within the range are included whether specifically disclosed. For example, if the range is from 1 to 10, the range would include every number within the range, such as 1; 1.1; 1.2; 1.3; 1.4; 1.5; 1.6; 1.7; 1.8; 1.9; 2; 2.1; 2.2; 2.3; 2.4; 2.5; 2.6; 2.7; 2.8; 2.9; 3; 3.1; 3.2; 3.3; 3.4; 3.5; 3.6; 3.7; 3.8; 3.9; 4; 4.1; 4.2; 4.3; 4.4; 4.5; 4.6; 4.7; 4.8; 4.9; 5; 5.1; 5.2; 5.3; 5.4; 5.5; 5.6; 5.7; 5.8; 5.9; 6; 6.1; 6.2; 6.3; 6.4; 6.5; 6.6; 6.7; 6.8; 6.9; 7; 7.1; 7.2; 7.3; 7.4; 7.5; 7.6; 7.7; 7.8; 7.9; 8; 8.1; 8.2; 8.3; 8.4; 8.5; 8.6; 8.7; 8.8; 8.9; 9; 9.1; 9.2; 9.3; 9.4; 9.5; 9.6; 9.7; 9.8; 9.9 and 10. It is further understood that “0” is not included in the range of less than or equal to unless specifically called out, and likewise that “100” is not included in the range of greater than or equal to unless specifically called out.

The term “comonomer” as used herein is meant to denote any monomer present within the polytetrafluoroethylene other than the tetrafluoroethylene monomer.

As used herein, the phrase “substantially only TFE monomer” or “homopolymer PTFE” is meant to denote that the PTFE resin contains (1) TFE monomer or (2) TFE monomer and an unquantifiable amount (trace amount) of comonomer.

As used herein, the term “modified PTFE” is meant to describe a reaction product of TFE monomer and at least one comonomer where the comonomer is present in the modified PTFE in an amount of at least about 0.001% to about 1% by weight polymerized units based on the total weight of modified PTFE.

As used herein, the term “dense” is meant to describe an article that has a void volume less than about 20%.

As used herein, the terms “width” and “length” are analogous to the x-direction and y-direction, respectively.

As used herein, the term “lubricant” is meant to describe a processing aid that includes, and in some embodiments, consists of, an incompressible fluid that is not a solvent for the polymer at processing conditions. The fluid-polymer surface interactions are such that it is possible to create a homogenous mixture.

### Description of Various Embodiments

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The present invention relates to dense articles including a dense polytetrafluoroethylene (PTFE) film based on a modified PTFE resin. This disclosure also relates to processes for making a dense polytetrafluoroethylene film. The dense articles exhibit improved physical and mechanical properties including superior optical properties (highly transmissive, low haze, low yellowness) in combination with desirable mechanical properties (such as flexibility, strength, and durability).

A modified PTFE resin is formed by a process in which tetrafluoroethylene monomers are copolymerized with at least one comonomer other than TFE. The comonomer may be an ethylenically unsaturated monomer having a reactivity with TFE so as to enable polymerization with the TFE monomers. For example, the comonomer may be a perfluoroalkyl ethylene monomer, such as perfluorobutylethylene (PFBE), perfluorohexylethylene (PFHE), and perfluoro-octylethylene (PFOE), or it may be a perfluoroalkyl vinyl ether monomer such perfluoro (methyl vinyl ether) (PMVE), perfluoro (ethyl vinyl ether) (PEVE), and perfluoro (propyl vinyl ether) (PPVE). For example, the perfluoroalkyl ethylene monomer may be a perfluoroalkylethylene having a formula F(CF₂)ₙCH═CH₂ wherein n is 4, 5, 6, 7, 8, 9 or 10. Preferably, the comonomer may be perfluorobutylethylene (n=4) or perfluoro-octylethylene (n=8).

The sheets, or films based on modified PTFE resin may be made in accordance with the teachings of U.S. Pat. No. 9,644,054 to Ford et al. The modified PTFE resin may be produced by a polymerization process that includes placing TFE monomer and at least one comonomer in a pressurized reactor, initiating the polymerization reaction with a free radical initiator, feeding TFE monomer and comonomer into the reaction vessel during the polymerization reaction, stopping the addition of comonomer at a point in the polymerization reaction prior to completion of the polymerization reaction, and continuing the polymerization reaction by feeding only TFE monomer into the reaction vessel until the reaction is complete. It is to be appreciated that more than one comonomer may be fed into a pressurized reactor to produce multi-component copolymers, such as, for example, terpolymers.

The initial addition of TFE monomer and comonomer may be introduced into the reactor vessel as a precharge. After the polymerization reaction has started, the comonomer and TFE monomer may be sequentially added, for example, with the comonomer being added prior to the TFE monomer. Alternatively, the TFE monomer and comonomer may be simultaneously added to the reaction vessel. The TFE monomer and comonomer may be introduced incrementally or intermittently to the reaction vessel during the polymerization reaction. Higher concentrations of comonomer in the modified PTFE produced are achieved by adding the comonomer to the reaction vessel at higher concentration levels.

Comonomer may be added to the reaction vessel in an amount of at least about 0.001% by weight, at least about 0.005% by weight, at least about 0.01% by weight, at least about 0.05% by weight, at least about 0.1% by weight, at least about 0.5% by weight, or at least about 1.0% by weight. It is to be noted that the % by weight described herein with reference to the addition of the TFE monomer and/or comonomer to the reaction vessel are based upon total weight of TFE monomer and comonomer fed into the reactor vessel.

In the polymerization reaction, substantially non-telogenic dispersing agents may be used. Ammonium perfluoro octanoic acid (APFO or “C-8”) is one non-limiting example of a suitable dispersing agent for the polymerization reaction. Programmed addition (precharge and pumping) may be utilized to add the dispersing agent to the reaction vessel. It is to be appreciated that ingredient purity is needed to achieve the desired properties in the dense articles described herein. Ionic impurities, which can increase ionic strength, in addition to soluble organic impurities, which can cause chain transfer or termination, are minimized or even eliminated. In at least one embodiment, ultra-pure water is employed.

The modified PTFE resin may contain comonomer in an amount of at least about 0.001% by weight, at least about 0.005% by weight, at least about 0.01% by weight, at least about 0.05% by weight, at least about 0.1% by weight, at least about 0.5% by weight, or at least about 1.0% by weight. Accordingly, the amount of tetrafluoroethylene (e.g., TFE monomer) that may be present in the modified PTFE resin may be less than about 99.999% by weight, less than about 99.995% by weight, less than about 99.99% by weight, less than about 99.95% by weight, less than about 99.9% by weight. In some embodiments, the modified PTFE resin may contain comonomer at least from about 0.001% by weight to about 1.0% by weight, or in any amount encompassed within this range.

The modified PTFE resin may be expandable and may be expanded to produce strong, useful, expanded modified PTFE articles having a microstructure of nodes interconnected by fibrils.

The modified PTFE resin particles may have a raw dispersion particle size below 240 nm, or below 200 nm, or below 150 nm, or below 110 nm, or below 90 nm, or below 70 nm, or below 50 nm, or below 30 nm, or below 20 nm. The modified PTFE resin particles may have a raw dispersion particle size ranging from above 20 nm to below 240 nm, or from above 70 nm to below 240 nm, or from above 110 nm to below 240 nm, or from above 150 nm to below 240 nm, or from above 200 nm to below 200 nm. The modified PTFE resin particles may also be blends of two of two or more raw dispersion particle sizes, such as for example, a raw dispersion particle size of about 240 nm and about 20 nm, or a blend of any other raw dispersion particle size between those endpoints.

The modified PTFE resin may be produced in the form of fine particles dispersed within an aqueous medium and may be processed into a dense polytetrafluoroethylene (PTFE) film. The dense PTFE film is produced directly from dried extrudate at a deformation temperature less than or equal to about 400° C., or greater than or equal to about 325° C. without increasing the porosity of the dried preform, as would conventionally be done in expansion processes.

To form the dense PTFE film, the modified PTFE resin may be subjected to a ram extrusion process where the modified PTFE resin is combined with a suitable lubricant (e.g., Isopar® K), blended, compressed into a pellet, and extruded through a die to form a tape. The direction of extrusion is referred to as the y-direction or longitudinal direction. The tape is then dried to remove or substantially remove the lubricant and form a dried extrudate or dried preform. The term “lubricant”, as used herein, is meant to describe a processing aid that includes, and in some embodiments, consists of, an incompressible fluid that is not a solvent for the polymer at processing conditions. Additionally, the fluid-polymer surface interactions are such that it is possible to create a homogenous mixture. The phrase “substantially all the lubricant” is meant to denote that the lubricant is nearly or completely removed from the modified PTFE resin tape to form the dried preform.

The dried preform tape may then be deformed or stretched in at least one direction at a temperature less than or equal to about 400° C., or from about 350° C. to about 400° C. to form a dense PTFE film. As used herein, the term “dense” is meant to describe a PTFE film or article that possesses a void volume less than about 20%. The dense PTFE film may possess a void volume less than about 20%, less than about 15%, less than about 10%, less than about 8%, less than about 5%, less than about 3%, or less than about 1%.

The dried preform tape may then be deformed or stretched at a stretch ratio of 5:1 or less in both the machine direction (MD) and the transverse direction (TD), wherein stretch ratio is defined as being equal to a final length over an initial length.

In another embodiment, the dried PTFE preform tape may be formed by a process including the following steps: (a) lubricating a population of polytetrafluoroethylene (PTFE) resin particles having a raw dispersion particle size of about 20 nm to about 240 nm to form a blend of lubricated particles; (b) subjecting the blend of lubricated particles to pressure and a temperature below about 350° C. to form a lubricated pellet; (c) extruding the lubricated pellet to form a lubricated polytetrafluoroethylene preform tape; and (d) heating the lubricated polytetrafluoroethylene preform tape to remove the lubricant to form a dried PTFE preform tape.

In some embodiments, the dense PTFE film is thin and may have a thickness less than about 1000 μm (1.0 mm), less than about 500 μm, less than about 100 μm, less than about 50 μm, less than about 10 μm, less than about 1 μm, less than about 0.5 μm, or less than about 0.1 μm, or less than about 0.05 μm. For example, dense PTFE film may have a thickness from about 0.04 μm to about 1.0 mm, or may have a thickness of any value encompassed with this range.

Additionally, the dense PTFE film may have an average haze coefficient of less than about 6% from 360 nm to 780 nm, or less than about 5% from 360 nm to 780 nm, less than about 4% from 360 nm to 780 nm, less than about 3% from 360 nm to 780 nm, less than about 2% from 360 nm to 780 nm, less than about 1% from 360 nm to 780 nm. The dense PTFE film may have an average haze coefficient within a range from about 1% from 360 nm to 780 nm to about 6% from 360 nm to 780 nm.

In some embodiments, the dense PTFE film may have a reduced scattering coefficient less than or equal to 2.9 mm⁻¹ at 400 nm, less than or equal to 2.5 mm⁻¹ at 400 nm, less than or equal to 2.3 mm⁻¹ at 400 nm, less than or equal to 2.0 mm⁻¹ at 400 nm, less than or equal to 1.7 mm⁻¹ at 400 nm, less than or equal to 1.5 mm⁻¹ at 400 nm, less than or equal to 1.3 mm⁻¹ at 400 nm, or less than or equal to 1.0 mm⁻¹ at 400 nm. The dense PTFE film may have a reduced scattering coefficient within a range from about 1.0 mm⁻¹ at 400 nm to about 2.9 mm⁻¹ at 400 nm.

The dense PTFE films and articles including the dense PTFE films may be utilized as barrier materials. The dense PTFE films may exhibit a methane permeability of less than about 20 μg*micron/cm²/min, less than about 15 μg*micron/cm²/min, less than about 10 μg*micron/cm²/min, less than about 5 μg*micron/cm²/min, less than about 1.0 μg*micron/cm²/min, or less than about 0.5 μg*micron/cm²/min. Further, the dense PTFE films have a matrix tensile strength in at least one direction that is greater than or equal to about 69 MPa, greater than or equal to about 125 MPa, greater than or equal to about 150 MPa, greater than or equal to about 175 MPa or greater than or equal to about 200 MPa, or higher.

The dense PTFE films and dense articles including the dense PTFE films may be laminated, adhered, or otherwise bonded (e.g., thermally, mechanically, or chemically) to a substrate. Non-limiting examples of suitable substrates include, but are not limited to, fluorinated ethylene propylene (FEP), perfluoroalkoxy alkane (PFA), polytetrafluoroethylene (PTFE), a polymer of tetrafluoroethylene, hexafluoropropylene, and vinylidene fluoride (THV), polyurethanes, polyamides, ethylene vinyl alcohol (EVOH), and polyvinyl chloride (PVC). The substrate may also be a metallic sheet, an inorganic sheet, or pressure sensitive adhesive. Such laminated structures may facilitate or enhance further bonding to additional layers, such as textiles.

Articles that include the dense PTFE films may exhibit excellent optical properties. Such a dense article may have an average total transmittance measured from 360 nm to 780 nm of at least about 93%, or of at least about 94%, or of at least about 95%. For example, a dense article may have an average total transmittance measured from 360 nm to 780 nm of from about 93% to about 95%.

Additionally, articles that include the dense PTFE films may have a yellowness index of about 3.0 or less, of about 2.5 or less, of about 2.0 or less, of about 1.5 or less, or of about 1.0 or less. For example, a dense article may have a yellowness index of from about 1.0 to about 3.0, or any value encompassed within that range.

An article that includes the dense PTFE film may be in the form of a sheet, a tube, or a self-supporting three-dimensional shape. Or the article may be included in a laminate or composite.

An article that includes the dense PTFE film may be a portable electronic device display, a flexible display, a solar panel, a personal computer, a television, a storage container or a sensor.

In summary, the article that includes the novel dense PTFE film prepared by the processes provided herein exhibits superior optical properties (highly transmissive, low haze, low yellowness), UV durable without compromising existing chemical and mechanical properties such as being chemical resistant, bendable/flexible, strong, and durable.

### TEST METHODS

It should be understood that although certain methods and equipment are described below, other methods or equipment determined suitable by one of ordinary skill in the art may be alternatively utilized.

### Examples

Unless defined otherwise herein, all technical and scientific terms used herein have the same meaning as commonly understood by one of ordinary skill in the art to which this invention belongs. The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Raw Dispersion Primary Particle Size (RDPS)

The RDPS was obtained by laser light scattering using a NanoBrook 90 Plus Particle Size Analyzer (Brookhaven Instruments, Holtsville, NY).

### Tensile Properties

Tensile properties of the films were measured on an Instron tensile tester based on the ASTM standard D412F. The tensile specimens were dog bone shaped with total length of 12.70 cm (5.0 in) and width of 0.64 cm (0.25 in). The gauge length was 5.89 cm (2.32 in) and crosshead speed was 47.12 cm/min (18.55 in/min). Three measurements were made for both MD and TD. The matrix tensile strength (MTS) was calculated using the following equation:

MTS=F/A

Where F is the maximum load in the test, A is the x-section area of PTFE. The x-section area of PTFE is not the same as the x-section area of the specimen due to potential pores/defects in the sample. The x-section area of PTFE can be calculated as follows:

$$A = \frac{m}{l * ρ}$$

Where m is the mass of the testing specimen, L is the length of the specimen, and p is the mean intrinsic density of PTFE, which is 2.18 g/cc.

### Optical Properties

One skilled in the art realizes that the optical properties of a flat sheet specimen, such as color, transmittance, and haze, are thickness dependent, unless the specimen is non-absorbing and exhibits zero bulk scattering. It is desired to quantify the magnitude of bulk scattering in flat sheet articles comprised of PTFE on a thickness normalized basis so that the intrinsic bulk scattering of a specimen can be determined and the intrinsic bulk scattering of flat sheet articles of varying thickness can be compared.

Radiative transfer (or transport) theory, more specifically the Inverse Adding Doubling (IAD) method, can be used to determine the thickness normalized optical properties of a flat sheet specimen as a function of wavelength, specifically the absorption coefficient μₐ [mm⁻¹], the scattering coefficient μₛ [mm⁻¹], and the anisotropy coefficient g (or asymmetry parameter). Three measurements as a function of wavelength are required to obtain the optical properties: the total transmittance Tₜ, the total reflectance Rₜ, and the unscattered transmittance T_{c}. If only Tₜ and Rₜ are measured, only μₐ and the reduced scattering coefficient μ′ₛ=(1−g)μₛ can be obtained. For non-absorbing specimens, μₐ=0 can be assumed; therefore, only Tₜ or Rₜ is required to obtain μ′ₛ since Tₜ+Rₜ=1. To obtain μ′ₛ, the refractive index n and thickness t [mm] of the specimen must also be known.

The reduced scattering coefficient μ′ₛ is a representation of the intrinsic bulk scattering of a specimen. For a given thickness, a PTFE flat sheet article of optimal transparency (maximal transmittance and minimal haze and color) will be obtained when μ′ₛ is minimized over the visible wavelength rage.

The IAD method was developed by Scott A. Prahl and has been used extensively in the biomedical field since the 1990's. The method is described in the following reference: S. A. Prahl, M. J. C. van Gemert, and A. J. Welch, “Determining the optical properties of turbid media by using the adding-doubling method.,” Appl. Opt., vol. 32, pp. 559-568, 1993.

The settings below were used in the IAD program. The index of refraction, thickness, total transmittance (M_T), and total reflectance (M_R) as calculated by 1−M_T were updated for each sample.
IAD1
1.3656 #Index of refraction of the sample (varies sample to sample)
1.0 #Index of refraction of the top and bottom slides
0.05319 #[mm] Thickness of sample (varies sample to sample)
0.0 #[mm] Thickness of slides
0.0 #[mm] Diameter of illumination beam
1.0 #Reflectivity of the reflectance calibration standard
0 #Number of spheres used for the measurement
   #Properties of sphere used for reflection measurements
203.2 #[mm] Sphere Diameter (8 in*25.4 mm/in)
31.75 #[mm] Sample Port Diameter
6.35 #[mm] Entrance Port Diameter
3.18 #[mm] Detector Port Diameter
0.975 #Reflectivity of the sphere wall
   #Properties of sphere used for transmission measurements
203.2 #[mm] Sphere Diameter (8 in*25.4 mm/in)
31.75 #[mm] Sample Port Diameter
0.00 #[mm] Entrance Port Diameter
3.18 #[mm] Detector Port Diameter
0.975 #Reflectivity of the sphere wall
2 #Two measurements, i.e., M_R, M_T, M_U

| #lambda | M_R | M_T |
|---|---|---|
| 2500 | 0.023452 | 0.976548 |
| 2499 | 0.035603 | 0.964397 |
| 2498 | 0.036976 | 0.963024 |

Cont'd to 250.

### Optical Measurements and Calculations

Optical measurements were determined according to ASTM D1003-13 (Standard Test Method for Haze and Luminous Transmittance of Transparent Plastics; ASTM International, West Conshohocken, PA). The incident light (T₁), total light transmitted by the specimen (T₂), light scattered by the instrument (T₃), and light scattered by the instrument and specimen (T₄) were measured over a wavelength range of 250 to 2500 nm with a 1 nm step using a Jasco v-670 UV-Vis-NIR spectrophotometer equipped with a Jasco iln-725 integrating sphere. The diffuse luminous transmittance (T_{d}), total luminous transmittance (T₁), and haze, % were calculated according to ASTM D1003-13. The CIELAB (L*a*b*) color and Yellowness Index (YI) were calculated from the total luminous transmittance (T₁) spectrum for a D65 illuminant, 10 degree observer and 10 nm interval according to ASTM E308-18 (Standard Practice for Computing the Colors of Objects by Using the CIE System) and ASTM E313-15 (Standard Practice for Calculating Yellowness and Whiteness Indices from Instrumentally Measured Color Coordinates), respectively (ASTM International, supra).

### Methane Permeability

### Standard Procedure:

The apparatus used to measure methane permeation comprised of a stainless steel test cell with a top half, a bottom half, an inlet for methane gas, and an inlet for zero air. The term “zero air” refers to compressed air passing through a catalyst bed to remove any hydrocarbons in the air so that the methane is the only hydrocarbon the FID detector measures. The bottom half of the test cell was first purged with zero air. The testing film is sandwiched between the two halves and sealed. A tight seal is formed by two o-rings.

Methane gas and zero air were then introduced into the test sample by way of the inlets. The flow of the methane gas and zero air were controlled using a needle valve and a mass flow controller (Model No. Brooks 5850E), respectively. Methane gas came in from the bottom inlet and came out through the bottom exhaust outlet, which ensured that there is no back pressure on the test sample. The methane gas which permeated through the test sample was carried in zero air and fed into the FID detector (Model 8800B, Baseline-Mocon, Inc.). The FID detector continuously measured the concentration of the methane gas, which permeated through the test sample. The detector was connected to a data acquisition system to acquire voltage signals which were then converted to methane concentration (Cmethane) values using a known three-point calibration curve.

The test duration lasted at least until the methane concentration reached a steady state. The test duration typically ranged from about 15 minutes to about 40 minutes. The average of the data (Cmethane) collected during the last two minutes of the test duration was reported.

The methane flux (in units of g/cm2/min) was calculated by the following equation:

$$Methane flux = 0.000654 * {C}_{methane} * R / A$$

wherein Cₘₑₜₕₐₙₑ is the average methane concentration in ppm, R is the flow rate of zero air in cm³/min, and A is the area of the test sample in cm². Methane permeation was measured in duplicate and the average value of methane flux based on two samples was reported.

### Example 1

### Perfluorobutyl Ethylene Modified Polytetrafluoroethylene Resin Using Process A

A perfluorobutyl ethylene (PFBE) modified PTFE resin (about 0.28 mol % (about 0.69 wt %) PFBE) with the raw dispersion particle size (RDPS) of about 169 nm was mixed with an isoparaffinic hydrocarbon lubricant (ISOPAR™ K, Exxon, Houston, TX), at a concentration of 0.218 g/g, subsequently blended, compressed into a cylindrical pellet, and thermally conditioned for 24 hours at a temperature of 49° C. The cylindrical pellet was then extruded into a tape with thickness of 0.521 mm through a rectangular die at a reduction ratio of 75. The resultant tape was then dried at 180° C. to remove the lubricant.

Based on the teaching of U.S. Pat. No. 9,644,054 to Ford et al., the tape was then placed in a pantograph machine and heated at 370° C. for 300 seconds and then stretched while maintaining the same temperature in the longitudinal direction and transverse direction simultaneously at a stretch ratio of 3.0 and 3.4, respectively. The average engineering strain rate was calculated to be about 6%/second. The resulting film thickness was 57.9 μm.

The mechanical and optical properties were determined according the testing methodology described above. Results are provided in Table 1.

### Example 2

### PFOE Modified PTFE Resin Using Process A

A perfluorooctyl ethylene (PFOE) modified PTFE resin (0.028 mol % (about 0.125 wt %) of PFOE) with the raw dispersion particle size (RDPS) of about 199 nm was mixed with an isoparaffinic hydrocarbon lubricant (ISOPAR™ K), at a concentration of 0.218 g/g, subsequently blended, compressed into a cylindrical pellet, and thermally conditioned for 24 hours at a temperature of 49° C. The cylindrical pellet was then extruded into a tape with thickness of 0.508 mm through a rectangular die at a reduction ratio of 75. The resultant tape was then dried at 180° C. to remove the lubricant.

Based on the teaching of U.S. Pat. No. 9,644,054 B2 to Ford et al., the tape was then placed in a pantograph machine and heated at 370° C. for 300 seconds and then stretched while maintain the same temperature in the longitudinal direction and transverse direction simultaneously at a ratio of 2.9 and 3.3, respectively. The average engineering strain rate was calculated to be about 6%/second. The resulting film thickness was 62.3 μm.

The mechanical and optical properties were determined according the testing methodology described above. Results are provided in Table 1.

### Example 3

### PFBE Modified PTFE Resin Using Process A

A perfluorobutyl ethylene (PFBE) modified PTFE resin (about 0.03 mol % (about 0.074 wt %) PFBE) raw dispersion particle size (RDPS) of about 220 nm was mixed with an isoparaffinic hydrocarbon lubricant (ISOPAR™ K), at a concentration of 0.218 g/g, subsequently blended, compressed into a cylindrical pellet, and thermally conditioned for 24 hr at a temperature of 49° C. The cylindrical pellet was then extruded into a tape with thickness of 0.508 mm through a rectangular die at a reduction ratio of 75. The resultant tape was then dried at 180° C. to remove the lubricant.

Based on the teaching of U.S. Pat. No. 9,644,054 B2 to Ford et al., the tape was then placed in a pantograph machine and heated at 370° C. for 300 seconds and then stretched while maintaining the same temperature in the longitudinal direction and transverse direction simultaneously at a stretch ratio of 3.5 and 3.5, respectively. The average engineering strain rate was calculated to be about 8%/s. The resulting film thickness was 53.8 μm.

The mechanical and optical properties were determined according the testing methodology described above. Results are provided in Table 1.

### Example 4

### (Comparative)

### Homopolymer PTFE Resin Using Process A

A homopolymer PTFE resin with the raw dispersion particle size (RDPS) of about 280 nm was mixed with an isoparaffinic hydrocarbon lubricant (ISOPAR™K), at a concentration of 0.218 g/g, subsequently blended, compressed into a cylindrical pellet, and thermally conditioned for 24 hours at a temperature of 49° C. The cylindrical pellet was then extruded into a tape with thickness of 0.533 mm through a rectangular die at a reduction ratio of 75. The resultant tape was then dried at 180° C. to remove the lubricant.

Following the general process of Example 1, the tape was then placed in a pantograph machine and heated at 370° C. for 300 seconds and then stretched while maintaining the same temperature in the longitudinal direction and transverse direction simultaneously at a stretch ratio of 3.3 and 3.3, respectively. The average engineering strain rate was calculated to be about 10%/second. The resulting film thickness was 64.0 μm.

The mechanical and optical properties were determined according the testing methodology described above. Results are provided in Table 1.

### Example 5

### (Comparative)

### PFBE Modified PTFE Resin Using Process B

A PFBE modified PTFE resin (about 0.03 mol % (about 0.074 wt %) PFBE) with the raw dispersion particle size (RDPS) of about 220 nm was mixed with an isoparaffinic hydrocarbon lubricant (ISOPAR™ K), at a concentration of 0.201 g/g, subsequently blended, compressed into a cylindrical pellet, and thermally conditioned for 24 hours at a temperature of 49° C. The cylindrical pellet was then extruded into a tape with thickness of 0.711 mm through a rectangular die at a reduction ratio of 150. The resultant tape was then dried at 180° C. to remove the lubricant.

Based on the general methodology of U.S. Pat. No. 7,521,010 B2 to Kennedy et al, the dried PTFE tape was then expanded in the y-direction between heated drums (drum temperatures 280° C.) at a linear rate of greater than 10%/second and a stretch ratio equal to 3. The tape was then expanded in the orthogonal direction (x-direction) at a linear rate greater than 10%/second, a temperature of about 325° C., and a stretch ratio equal to 4.

The resulting membrane was then densified according to U.S. Pat. No. 5,374,473 to Knox et al. and U.S. Pat. No. 7,521,010 B2 to Kennedy et al. The densified article was then placed in a pantograph machine wherein the material was heated above the crystalline melt temperature of PTFE by exposure to air temperature of about 370° C. for a period of 125 seconds. The sample, while still heated at 370° C., was then stretched in the x-direction at a stretch ratio equal to 3 and average engineering strain rate of 8%/second. The resulting film thickness was 53.2 μm.

The mechanical and optical properties were determined according the testing methodology described above. Results are provided in Table 1.

### Example 6

### PFBE Modified PTFE Resin Using Process A

A PFBE modified PTFE resin (about 0.03 mol % (about 0.074 wt %) PFBE) with the raw dispersion particle size (RDPS) of about 220 nm was mixed with an isoparaffinic hydrocarbon lubricant (ISOPAR™K), at a concentration of 0.218 g/g, subsequently blended, compressed into a cylindrical pellet, and thermally conditioned for 24 hours at a temperature of 49° C. The cylindrical pellet was then extruded into a tape with thickness of 0.508 mm through a rectangular die at a reduction ratio of 75. Two layers of the resultant tape were compressed together on a calendaring machine at 49° C. The resultant tape was then dried at 180° C. to remove the lubricant.

Based on the teaching of U.S. Pat. No. 9,644,054 B2 to Ford et al., the tape was then placed in a pantograph machine and heated at 370° C. for 300 seconds and then stretched while maintain the same temperature in the longitudinal direction and transverse direction simultaneously at a stretch ratio of 3.5 and 3.5, respectively. The average engineering strain rate was calculated to be about 8%/second. The resulting film thickness was 99.7 μm.

The mechanical and optical properties were determined according the testing methodology described above. Results are provided in Table 1.

### Example 7

### PFBE Modified PTFE Resin Using Process A

A PFBE modified PTFE resin (about 0.21 mol % (about 0.52 wt %) PFBE) with the raw dispersion particle size (RDPS) of about 128 nm was mixed with an isoparaffinic hydrocarbon lubricant (ISOPAR™ K), at a concentration of 0.234 g/g, subsequently blended, compressed into a cylindrical pellet, and thermally conditioned for 24 hours at a temperature of 49° C. The cylindrical pellet was then extruded into a tape with thickness of 0.584 mm through a rectangular die at a reduction ratio of 75. The resultant tape was then dried at 180° C. to remove the lubricant.

Based on the teaching of U.S. Pat. No. 9,644,054 B2 to Ford et al., the tape was then placed in a pantograph machine and heated at 370° C. for 300 seconds and then stretched while maintain the same temperature in the longitudinal direction and transverse direction simultaneously at a stretch ratio of 3.4 and 3.6, respectively. The average engineering strain rate was calculated to be about 6%/second. The resulting film thickness was 49.6 μm.

The mechanical and optical properties were determined according the testing methodology described above. Results are provided in Table 1.

### Example 8

### (Comparative)

### Skived PTFE (2 Mil)

A 56.7 μm skived PTFE film was acquired from Rogers Corporation (DeWAL DW200; Rogers Corporation, Chandler, AZ). The mechanical and optical properties were determined according the testing methodology described above. Results are provided in Table 1.

### Example 9

### (Comparative)

### TFE-VDF Copolymer Resin (27.9 Mol % VDF) Using Process A

A dense film from a TFE-VDF copolymer resin (27.9 mol % (about 19.9 wt %) vinylidene difluoride (VDF)) with the raw dispersion particle size (RDPS) of about 321 nm was prepared according to Example 1 of U.S. Pat. No. 9,644,054 B2 to Ford et al.

The mechanical and optical properties were determined according the testing methodology described above. Results are provided in Table 1.

TABLE 1
Sample summary and results.

| | | | | | | | | Average | | Reduced | |
|---|---|---|---|---|---|---|---|---|---|---|---|
| | | | | | | | Thickness | total | Average | scattering | |
| | | | | | | | normalized | transmittance | Haze | coef- | |
| | | | | Film | MTS | MTS | methane | 360 nm to | (%) @ | ficient @ | |
| | Prep. | Comonomer | RDPS | Thickness | MD | TD | permeability | 780 nm | 360 nm- | 400 nm | Yellowness |
| Example | Method | (mol %) | (nm) | (μm) | (MPa) | (MPa) | (μg*μm/cm²/min) | (%) | 780 nm | (mm⁻¹) | index |
| 1 | A | PFBE | 169 | 57.9 | 229.6 | 228.9 | 0.95 | 94.2 | 3.36 | 1.77 | 1.91 |
| | | (0.28) | | | | | | | | | |
| 2 | A | PFOE | 199 | 62.3 | 205.4 | 219.4 | 0.97 | 94.1 | 2.57 | 1.37 | 1.46 |
| | | (0.028) | | | | | | | | | |
| 3 | A | PFBE | 220 | 53.8 | 195.4 | 161.0 | 0.74 | 94.3 | 3.04 | 1.61 | 1.51 |
| | | (0.03) | | | | | | | | | |
| 4 | A | none | 280 | 64.0 | 195.2 | 176.1 | 0.71 | 91.8 | 6.82 | 3.00 | 3.36 |
| | | (0.00) | | | | | | | | | |
| 5 | B | PFBE | 220 | 53.2 | 186.0 | 215.5 | 1.22 | 90.9 | 9.56 | 4.18 | 3.53 |
| | | (0.03) | | | | | | | | | |
| 6 | A | PFBE | 220 | 99.7 | 199.1 | 173.1 | 0.88 | 93.3 | 3.41 | 1.51 | 2.69 |
| | | (0.03) | | | | | | | | | |
| 7 | A | PFBE | 128 | 49.6 | 223.5 | 190.6 | 1.32 | 95.2 | 1.38 | 1.09 | 1.09 |
| | | (0.21) | | | | | | | | | |
| 8 | Skived | none | N/A | 56.7 | 54.9 | 35.9 | 1.20 | 90.6 | 25.98 | 3.80 | 3.01 |
| | PTFE | (0.00) | | | | | | | | | |
| 9 | A | VDF | 321 | 43.4 | 162.6 | 140.0 | 0.31 | 91.2 | 9.48 | 4.48 | 3.14 |
| | | (27.9%) | | | | | | | | | |

1. An article comprising:
a dense polytetrafluoroethylene (PTFE) film having:
an average haze coefficient of less than about 6% from 360 nm to 780 nm; and
a reduced scattering coefficient less than or equal to 2.9 mm⁻¹ at 400 nm.

2. The article of claim 1 wherein the average total transmittance measured from 360 nm to 780 nm is at least 93%.

3. The article of claim 1, wherein the article has a yellowness index of about 3.0 or less.

4. The article of claim 1, wherein the dense film has a thickness from about 0.04 μm to about 1.0 mm.

5. The article of claim 1, wherein the dense PTFE film has a matrix tensile strength in a machine direction and a transverse direction of at least 69 MPa.

6. The article of claim 1, wherein the dense PTFE film has a thickness normalized methane permeability less than about 20 μg*micron/cm²/min.

7. The article of claim 1, wherein the dense PTFE film comprises from about 0.001 to about 1 wt % of at least one ethylenically unsaturated monomer.

8. The article of claim 7, wherein the ethylenically unsaturated monomer is a perfluoroalkylethylene having a formula F(CF₂)ₙCH═CH₂ wherein n is 4, 5, 6, 7, 8, 9 or 10.

9. (canceled)

10. The article of claim 1, wherein the article is in the form of a sheet, a tube, or a self-supporting three-dimensional shape, or is a portable electronic device display, a flexible display, a solar panel, a personal computer, a television, a storage container or a sensor.

11. (canceled)

12. A laminate comprising the article of claim 1.

13. A process to form a dense polytetrafluoroethylene film comprising:
stretching a dried PTFE preform tape comprising modified PTFE resin having a raw dispersion particle size of less than 240 nm, in at least one direction at a temperature at or above PTFE crystalline melting temperature to form a dense polytetrafluoroethylene (PTFE) film having
(a) an average haze coefficient of less than about 6% from 380 nm to 780 nm; and
(b) a reduced scattering coefficient less than or equal to 2.9 mm-1 at@400 nm.

14. The process of claim 13, wherein the stretching occurs at a temperature from about 325°° C. to about 400° C.

15. The process of claim 13, wherein the stretching step uses a stretch ratio of 5:1 or less in both the machine direction (MD) and the transverse direction (TD).

16. The process of claim 13, wherein the dense polytetrafluoroethylene film has a matrix tensile strength in a machine direction and a transverse direction of at least 69 MPa.

17. The process of claim 13, wherein the dense polytetrafluoroethylene film has a void volume less than about 20%, or wherein the dense PTFE film has a methane permeability less than about 20 μg*micron/cm²/min, or wherein the dense film has a thickness from about 0.04 μm to about 1.0 mm, or wherein the dried PTFE preform tape is formed from a PTFE resin comprising from about 0.001 wt % to about 1 wt % of at least one ethylenically unsaturated monomer.

18.-19. (canceled)

20. The process of claim 19, wherein the ethylenically unsaturated monomer is a perfluoroalkylethylene having a formula F(CF₂)ₙCH═CH₂ wherein n is 4, 5, 6, 7, 8, 9 or 10.

21.-22. (canceled)

23. The process of claim 13, wherein the dried PTFE preform tape is formed by process steps comprising:
(a) lubricating a population of polytetrafluoroethylene (PTFE) resin particles having a raw dispersion particle size from about 110 nm to about 240 nm to form a blend of lubricated particles;
(b) subjecting the blend of lubricated particles to pressure and a temperature below about 350° C. to form a lubricated pellet;
(c) extruding the lubricated pellet to form a lubricated polytetrafluoroethylene preform tape; and
(d) heating the lubricated polytetrafluoroethylene preform tape to remove the lubricant to form a dried PTFE preform tape.

24. The process of claim 23, wherein the population of PTFE resin particles comprise from about 0.001 wt % to about 1 wt % of at least one ethylenically unsaturated monomer.

25. The process of claim 23, wherein the ethylenically unsaturated monomer is a perfluoroalkylethylene having a formula F(CF₂)ₙCH═CH₂ wherein n is 4, 5, 6, 7, 8, 9 or 10.
